(19) United States
(12) Patent Application Publication
(10) Pub. No.: US 2004/0120789 A1
(43) Pub. Date: Jun. 24, 2004

(54) Female screw mechanism and nut

(76) Inventor: Michio Masuda, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/679,422

(22) Filed: Oct. 7, 2003

(30) Foreign Application Priority Data
Oct. 8, 2002 (JP) 2002-328889
Dec. 20, 2002 (JP) 2002-383423

(51) Int. Cl. F16B 37/12

(52) U.S. Cl. 411/178

(57) ABSTRACT

A female screw mechanism and a nut, comprising an insert attached to a female screw. The diameter of at least one turn at one end of the insert on the side for the insertion of a male screw into the insert is smaller than the diameter of the male screw. The other end of the insert is fixed to a female screw component, such as the nut, by welding, adhesive bonding, etc. A bent portion on the other end of the insert may be fixed by being fitted in a groove in the female screw component.

### BACKGROUND OF THE INVENTION

1. Field of the Invention

The present invention relates to a female screw mechanism and a nut for fixing members.

2. Description of the Related Art

In general, screws are used to fix a member to another member or remove it as required.

However, many screws need not be disengaged or should not be loosened or disengaged after they are fixed once. Unexpectedly disengaged screws may be dangerous to civil engineering machines, transportation vehicles, etc., for example, and loosened screws may be a hindrance to the use of some structures, such as piping of buildings, handrails, doors, etc.

In many cases, fastened screws are loosened or disengaged by vibrations or shocks that act on them. In some cases, they may be loosened by artificial mistake or with malicious intent.

### SUMMARY OF THE INVENTION

The present invention has been contrived in consideration of these circumstances, and its object is to provide a female screw mechanism and a nut free from unexpected loosening or disengagement.

In order to achieve the above object, a female screw mechanism according to the present invention is designed so that an insert is attached to a female screw of a component (a component having a female screw is hereinafter referred to as component). The diameter of at least one turn at one end of the insert on the side for the insertion of a male screw into the insert is smaller than the diameter of the male screw. The other end of the insert is fixed to a part of the component.

The other end of the insert may be fitted in a depression in the component for use as means for fixing the insert to the component.

The means for fixing the insert to the component may be integrating means such as welding or adhesive bonding.

The means for fixing the insert to the component may be frictional force between the insert and the female screw.

The component may be any of nuts having various shapes.

### BRIEF DESCRIPTION OF THE DRAWINGS

FIG. 1 is a perspective view of an insert;

FIG. 2 is a sectional view of a wire of the insert;

FIG. 3 is a perspective view showing the insert fixed to a nut;

FIG. 4 is a sectional view showing members clamped by means of the nut;

FIG. 5 is a perspective view of another insert;

FIG. 6 is a perspective view showing the second insert attached to a nut;

FIG. 7 is a sectional view showing members clamped by means of the nut;

FIG. 8 is a perspective view showing another embodiment; and

FIG. 9 is a side view of another insert.

### DESCRIPTION OF THE EMBODIMENTS

A first embodiment of the present invention will be described first.

In the description of the embodiment to follow, a nut will be given as an example of a component.

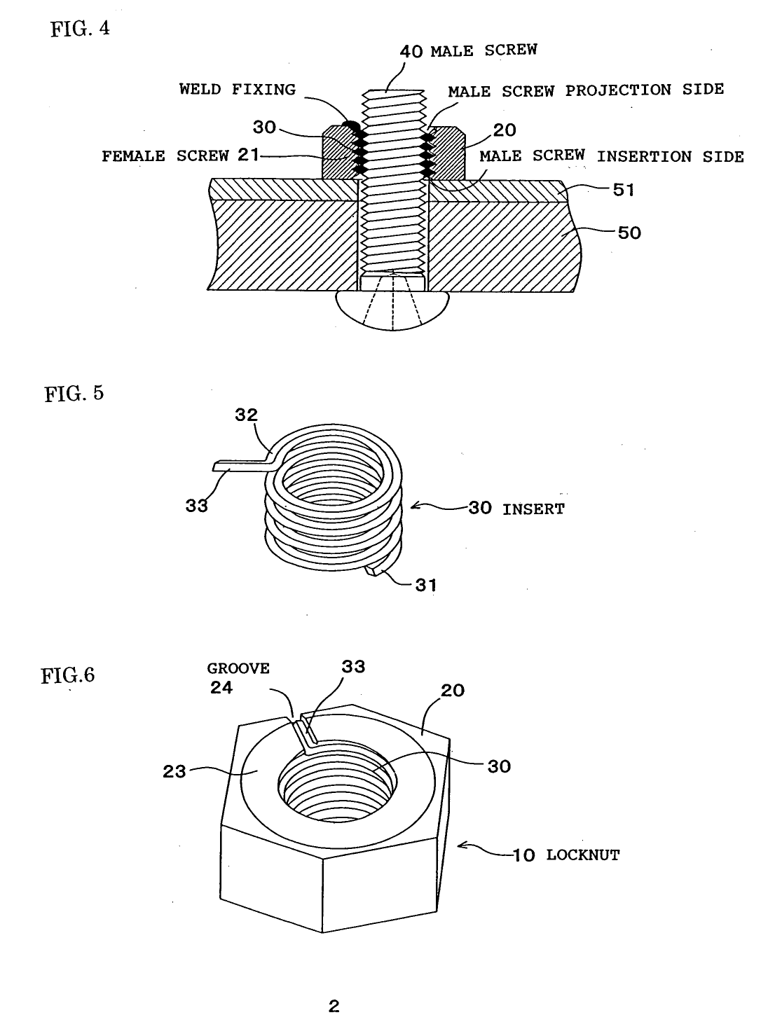

(a) General Configuration (FIGS. 3 and 4)

A nut 20 is formed by inserting an insert 30 into a female screw 21.

A male screw 40, such as a bolt, is passed through apertures in members 50 and 51 that require clamping, and the nut 20 is fastened on the male screw 40 that projects from the member 51.

(b) Insert

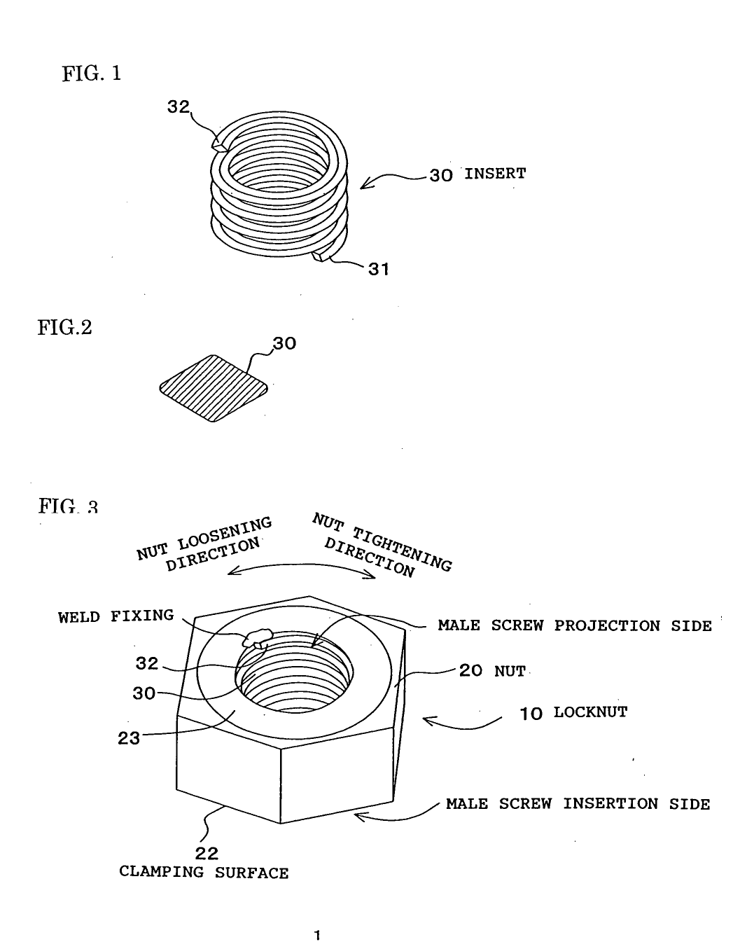

The insert 30 is a screw insert (spiral coil shaped insertion body) that is formed by coiling a wire having a rhombic cross section (see FIG. 2) to a size that matches the screw thread, as shown in FIG. 1.

Conventionally, an insert is designed to be fitted in a female screw of a soft material. After it is fitted in position, its straight breakable portion can be removed. One such insert is described in Japanese Patent Application Laid-open No. 10-331829, for example.

The insert 30 of the present embodiment, unlike the conventional one, is not provided with any breakable portion, such as the one shown in FIG. 1.

At least one turn at one end 31 (on the insertion side for the male screw 40) of the insert 30 shown in FIG. 1 has a diameter that is a little smaller than the diameter of the bolt or male screw 40 so that the insert 30 can be closely wound on the male screw 40 by spring characteristics.

The diameters of other parts of the insert 30 may be a little smaller or greater than that of the male screw 40.

The insert 30 is inserted into the female screw 21 of the nut 20 by screwing, as shown in FIGS. 3 and 4, and one end 32 (on the side of projection of the male screw 40) and a part (upper surface 23) of the nut 20 are fixed to each other by welding or the like.

The insert 30 may be fixed to the nut 20 by soldering or adhesive bonding in place of welding.

(c) Use of Nut (FIGS. 3 and 4)

When the nut 20 is used, its clamping surface 22 (small-diameter side of the insert 30) is located on the side for the insertion of the male screw 40, and the screw 40 projects from the upper surface 23 (side on which the insert 30 is fixed).

If the male screw 40 is rotated (clockwise for the illustrated right-handed screw) to be pushed in from the male screw insertion side, the insert 30 in contact with the male screw 40 is urged to rotate together with the screw 40 by frictional force, since the diameter of the insert 30 is smaller than that of the screw 40.

Since the one end 32 of the insert 30 is fixed, however, the insert 30 is twisted without being allowed to rotate.

Since the insert 30, a right-handed screw, is twisted clockwise, it spreads outward so that its diameter increases. If the diameter of the insert 30 becomes a little greater than that of the male screw 40, the male screw 40 advances rotating and sliding along the insert 30.

The mechanism is manufactured with a dimensional allowance such that some gaps can be formed between the male screw 40, insert 30, and female screw 21 in this state. Without this allowance, the insert 30 cannot spread satisfactorily, so that the male screw 40 is fastened and prevented from advancing.

By rotating the male screw 40 or the nut 20 in this manner, the members 50 and 51 between them can be clamped (see FIG. 4).

In the clamped state, the inside and outside of the insert 30 adhere to the male screw 40 and the female screw 21, respectively, thereby transmitting clamping force to both the screws.

(d) Locking Effect of Nut

If the nut 20 is rotated counterclockwise to be loosened from the clamped state, the fixed part of the insert 30 that is fixed to the nut 20 on the male screw projection side is pulled in the rotating direction.

Thus, the insert 30 that is wound on the male screw 40 is further pulled in the winding direction by spring characteristics, whereupon it is coiled more tightly.

As this is done, the frictional force between the insert 30 and the male screw 40 increases in proportion to the winding force, and becomes great enough to prevent dislocation.

The locking effect of the nut 20 is produced in this manner.

If a greater turning force is applied to the nut 20, the insert 30 is elongated, deformed, and broken in the end.

The following is a description of a second embodiment of the invention.

Although the insert 30 is fixed integrally to the nut 20 according to the first embodiment, it may alternatively be fixed separably.

One end 32 (on the side of projection of a male screw 40) of an insert 30 may be bent in the manner shown in FIG. 5. In this case, a bent portion 33 is fitted in a groove 24 that is formed on an upper surface 23 of a nut 20, as shown in FIG. 6, whereby the one end 32 of the insert 30 is fixed immovably.

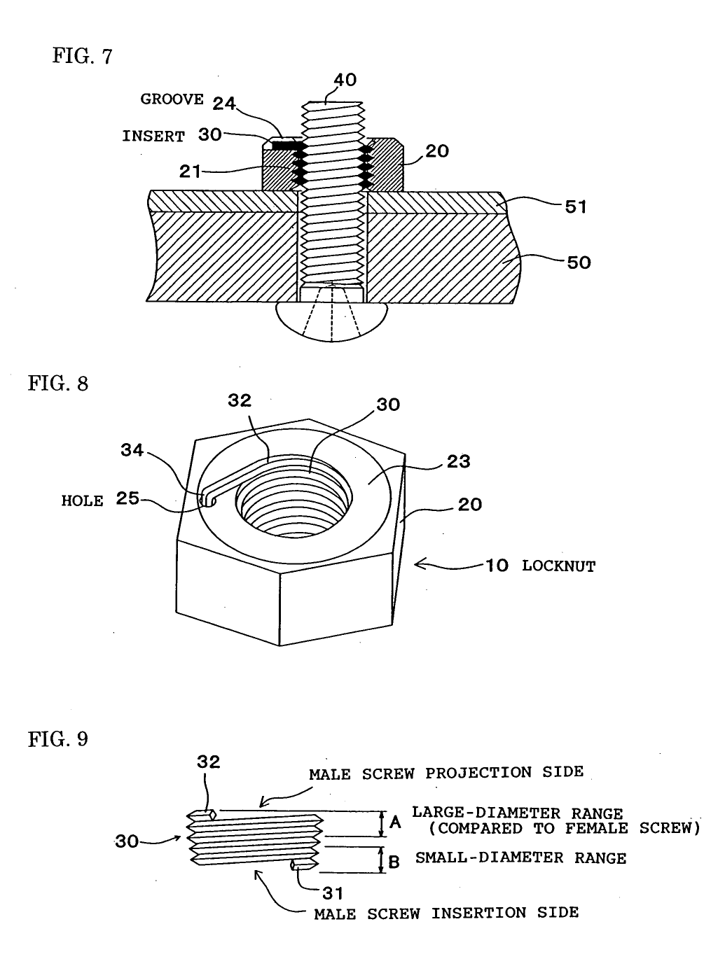

FIG. 7 shows the way this nut 20 is used. The locking effect of the nut 20 is produced in the same manner as in the first embodiment.

The following is a description of a third embodiment of the invention.

As shown in FIG. 8, one end 32 of an insert 30 may be bent so that a bent end 34 is fixedly fitted in a hole 25 in an upper surface 23 of a nut 20.

The following is a description of a fourth embodiment of the invention.

As shown in FIG. 9, the male screw projection side, including one end 32 of an insert 30, may be formed having a diameter greater than that of a female screw 21 of a nut 20.

When the insert 30 is inserted in the nut 20, a large-diameter portion A is brought intimately into contact with the female screw 21 by spring characteristics, and its movement is prevented by the force of friction with the female screw 21. More reliable fixation can be secured if the insert 30 and the female screw 21 are fixed with an adhesive agent on their respective contact surfaces.

In this example, one end 31 (on the small-diameter side for the male screw 40) is located on the side for the insertion of the male screw 40.

A small-diameter range B of the insert 30 is an essential factor that settles the force with which the insert 30 is wound on the male screw 40. The range B requires at least one turn and preferably two or more turns.

Likewise, adhesion of the insert 30 to the female screw 21 that produces satisfactory frictional force requires at least one turn for the large-diameter range A, and preferably two or more turns. Although the nut is a hexagon nut according to any of the foregoing embodiments, it may be a nut of any other shape.

The present invention, arranged in this manner, can provide the following effects.

(a) Once fastened, the mechanism of the invention will never be loosened. Therefore, the mechanism is applicable to various fields, such as fixation of mechanical parts on which vibrations and shocks act, as well as permanent fixation of buildings, screwing of uncheckable piping, etc.

(b) Further, the mechanism of the invention is applicable to fixation of outdoor structures that may possibly be removed with malicious intent, safety locknuts for medical appliances, etc.

What is claimed is:

1. A female screw mechanism in which an insert formed by coiling a wire having a rhombic cross section is attached to a female screw of a component, wherein
the diameter of at least one turn at one end of the insert on the side for the insertion of a male screw into the insert is smaller than the diameter of the male screw, and
the other end of the insert is fixed to a part of the component.

2. A nut having the female screw mechanism according to claim 1.

3. The nut according to claim 2, wherein the other end of the insert is fitted in a depression in the nut for use as means for fixing the insert to the nut.

4. The nut according to claim 2, wherein the means for fixing the insert to the nut is integrating means such as welding or adhesive bonding.

5. The nut according to claim 2, wherein the means for fixing the insert to the nut is frictional force between the insert and the female screw.
